(19) United States
(12) Patent Application Publication
(10) Pub. No.: US 2018/0169867 A1
(43) Pub. Date: Jun. 21, 2018

(54) MANIPULATOR SYSTEM

(71) Applicant: OLYMPUS CORPORATION, Tokyo (JP)

(72) Inventors: Masaru Yanagihara, Tokyo (JP); Kosuke Kishi, Tokyo (JP)

(21) Appl. No.: 15/869,851

(22) Filed: Jan. 12, 2018

Related U.S. Application Data
(63) Continuation of application No. PCT/JP2016/065955, filed on May 31, 2016.

(30) Foreign Application Priority Data
Jul. 31, 2015 (JP) 2015-152138

(51) Int. Cl. B25J 13/02; B25J 9/04; B25J 9/10; B25J 9/00

(52) U.S. Cl. CPC B25J 13/02; B25J 9/04; B25J 3/00; B25J 9/0009; B25J 9/10

(57) ABSTRACT

A manipulator system including a manipulator having: an insertion part; a first bend joint configured to pivot a distal end part of the insertion part about an axis perpendicular to the longitudinal axis of the insertion part; a rotation joint configured to rotate the distal end part about the longitudinal axis; and an operation input part configured to input an operation instruction. The operation input part includes: a bending-operation input part configured to input an operation instruction to the bend joint; a rotation-operation input part configured to input an operation instruction to the rotation joint; and a control unit including a hardware. The control unit is configured to control to move the rotation-operation input part or the rotation joint such that the relative angle between the operation instruction and the rotation angle of the rotation joint is 0° or ±180°.

### CROSS-REFERENCE TO RELATED APPLICATIONS

This is a continuation of International Application PCT/JP20181065955, with an international filing date of May 31, 2016, which is hereby incorporated by reference herein in its entirety. This application claims the benefit of Japanese Patent Application No. 2015-152138, filed on Jul. 31, 2015, the content of which is incorporated herein by reference.

### FIELD

The present invention relates to a manipulator system.

### BACKGROUND

In a known related-art master-slave manipulator system, manipulators are operated according to operation inputs to operation input devices operated by an operator.

In such a manipulator system, when the operation input devices and the manipulators are to be operably connected from a state in which clutches are disengaged, and the operation input devices and the manipulators are not operably connected, rough positioning is performed by manually moving the operation input devices so as to conform to the states of the manipulators, and then, the clutches are engaged.

{PTL 1} Japanese Unexamined Patent Application, Publication No. 2006-334695

### SUMMARY

An object of the present invention is to provide a manipulator system in which it is possible to move manipulators as an operator intends, regardless of the state of rotation joints.

An aspect of the present invention provides a manipulator system includes a manipulator. The manipulator includes an insertion part: a first bend joint configured to pivot a distal end part of the insertion part about an axis perpendicular to the longitudinal axis of the insertion part; a rotation joint configured to rotate the distal end part about the longitudinal axis; and an operation input part configured to input an operation instruction. The operation input part includes a bending-operation input part configured to input an operation instruction to the bend joint; a rotation-operation input part configured to input an operation instruction to the rotation joint; and a control unit comprising a hardware. The control unit is configured to control to move the rotation-operation input part or the rotation joint such that the relative angle between the operation instruction and the rotation angle of the rotation joint is 0° or ±180°.

In the above aspect, the bend joint may include a second bend joint configured to rotate the distal end part about axes perpendicular to each other, and the bending-operation input part configured to input the operation instruction to the first bend joint and the second bend joint.

In the above aspect, the control unit may move the rotation-operation input part or the rotation joint such that the relative angle between the operation instruction input to the rotation-operation input part and the rotation angle of the rotation joint is 0°, ±90°, or ±180°.

In the above aspect, the operation instruction input by the bending-operation input part may be speed instructions to the first bend joint and the second bend joint.

In the above aspect, the bending-operation input part may include an urging member configured to urge the handle in a direction in which the handle returns to the origin position.

In the above aspect, the bending-operation input part may include an origin notification part configured to allow the operator to recognize the origin of the handle.

### BRIEF DESCRIPTION OF THE DRAWINGS

FIG. 1 is a diagram showing the overall configuration of a manipulator system according to an embodiment of the present invention.

FIG. 2 is a perspective view showing a part of the manipulator system in FIG. 1.

FIG. 3 is an enlarged perspective view showing a distal end part of an overtube of the manipulator system in FIG. 1.

FIG. 4 is a schematic view showing the axis configurations of movable parts of the manipulator system in FIG. 1.

FIG. 5 is a diagram showing an example of an operating part of the manipulator system in FIG. 1.

FIG. 6A is a schematic view for explaining a related-art control method in which the reference is positioned at the base of the movable parts, showing a movement when the rotation joint is at 0°.

FIG. 6B is a schematic view for explaining a related-art control method in which the reference is positioned at the base of the movable parts, showing a movement when the rotation joint is at 180°.

FIG. 7A is a schematic view for explaining a method of controlling the manipulator system in FIG. 1 in which the reference is positioned between the rotation joint and the bend joint, showing a movement when the rotation joint is at 0°.

FIG. 7B is a schematic view for explaining a method of controlling the manipulator system in FIG. 1 in which the reference is positioned between the rotation joint and the bend joint, showing a movement when the rotation joint is at 180°.

FIG. 8 is a schematic view showing the axis configurations in a modification of the movable parts of the manipulator system in FIG. 4.

FIG. 9 shows a modification of the operating part of the manipulator system in FIG. 5.

### DETAILED DESCRIPTION

A manipulator system 1 according to an embodiment of the present invention will be described below with reference to the drawings.

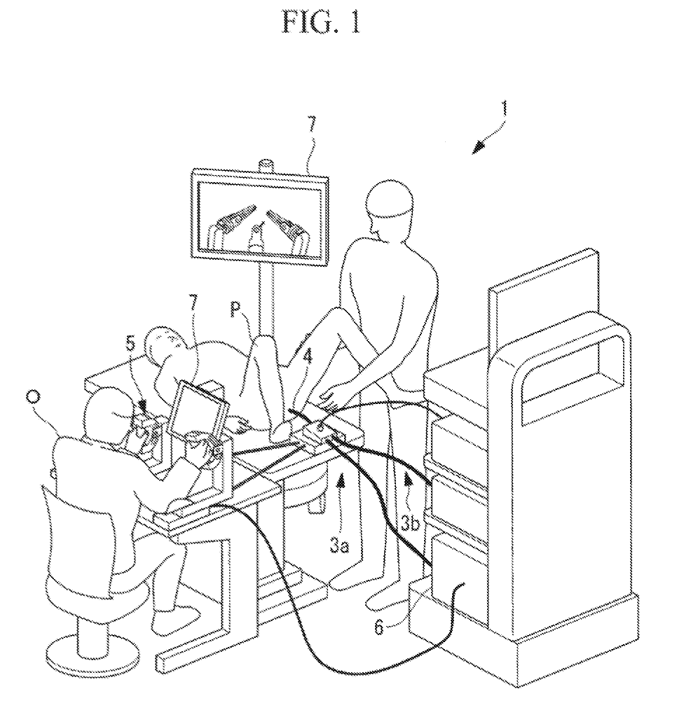

As shown in FIG. 1, a manipulator system 1 according to this embodiment includes: an endoscope 2 and two manipulators 3a and 3b, which are to be inserted into the body of a patient P; an overtube 4 that accommodates the manipulators 3a and 3b; operating parts (operation input parts) 5 that are operated by an operator O: a control unit 6 that controls the manipulators 3a and 3b according to operations input to the operating parts 5; and a monitor 7.

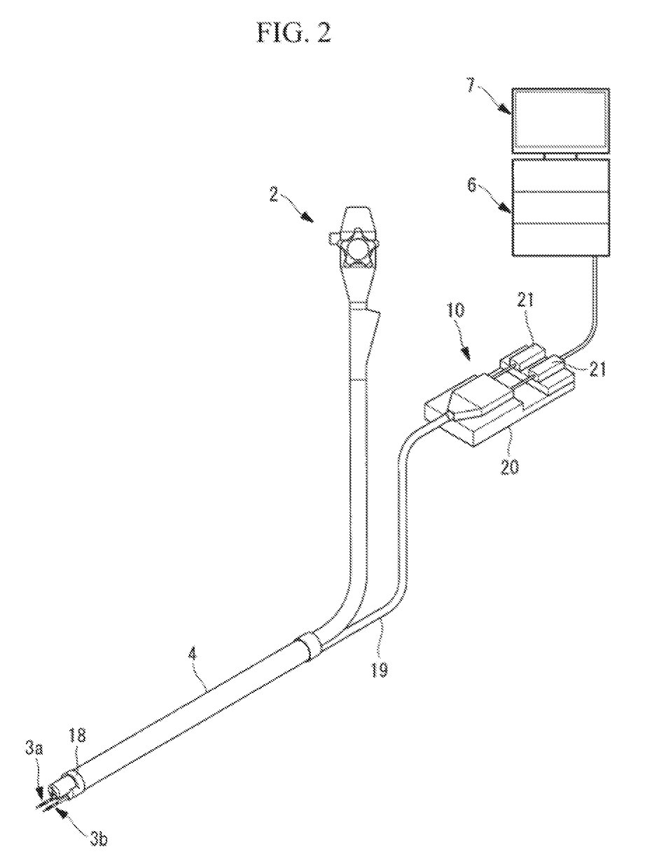

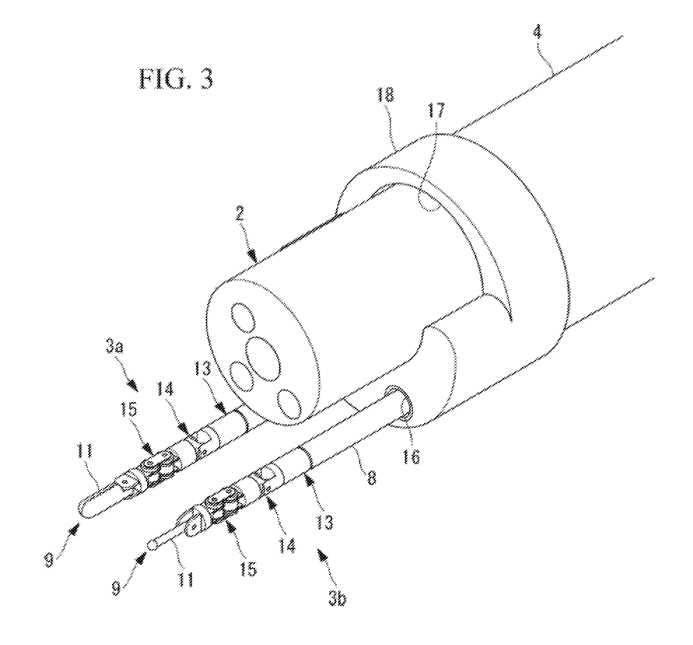

As shown in FIGS. 2 and 3, the manipulators 3a and 3b include an insertion part 8 that is to be inserted into the body of the patient P through a channel 16 in the overtube 4, a movable part 9 provided at the distal end of the insertion part 8, and a driving part 10 that is provided at the proximal-end side of the insertion part 8 and that drives the movable part 9 via a motive-power transmission member, such as a wire (not shown).

The movable part 9 includes a treatment part (distal end part) 11 that is disposed at the extreme distal end and acts on an affected part in the body to treat the affected part, and a plurality of joints 12, 13, 14, and 15 that change the distal-end position and orientation of the treatment part 11.

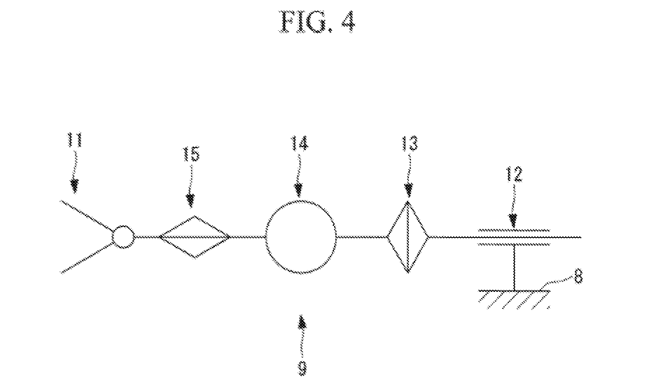

The joints 12, 13, 14, and 15 of the movable part 9 have axis configurations shown in FIG. 4.

Specifically, in order from the proximal-end side connected to the insertion part 8, there are the slide joint 12 that moves the treatment part 11 forward and backward in the longitudinal axis direction of the insertion part 8, the rotation joint 13 that rotates the treatment part 11 about the longitudinal axis, the first bend joint (bend joint) 14 that causes the treatment part 11 to pivot about an axis perpendicular to the longitudinal axis, and the second bend joint (bend joint) 15 that causes the treatment part 11 to pivot about an axis perpendicular to the axis of the first bend joint 14 and the longitudinal axis.

As shown in FIGS. 2 and 3, the overtube 4 is made of a flexible material and includes a distal-end-side tubular part 18 having two manipulator channels 16 through which the manipulators 3a and 3b pass and a single endoscope channel 17 through which the endoscope 2 passes, and a proximal-end-side tubular part 19 having extension channels (not shown) extending so as to extend the two manipulator channels 16 toward the proximal-end side from the proximal end of the distal-end-side tubular part 18.

As shown in FIG. 2, the driving part 10 of the manipulators 3a and 3b includes a driving part body 20 having motors (not shown), and manipulator-side driving parts 21 that are attachable to and detachable from the driving part body 20 and that transmit the driving forces of the motors to the motive-power transmission members in the insertion parts 8 when attached to the driving part body 20.

The driving part 10 includes sensors (not shown) that detect the angles and movement amounts of the joints 12, 13, 14, and 15, which constitute the movable parts 9.

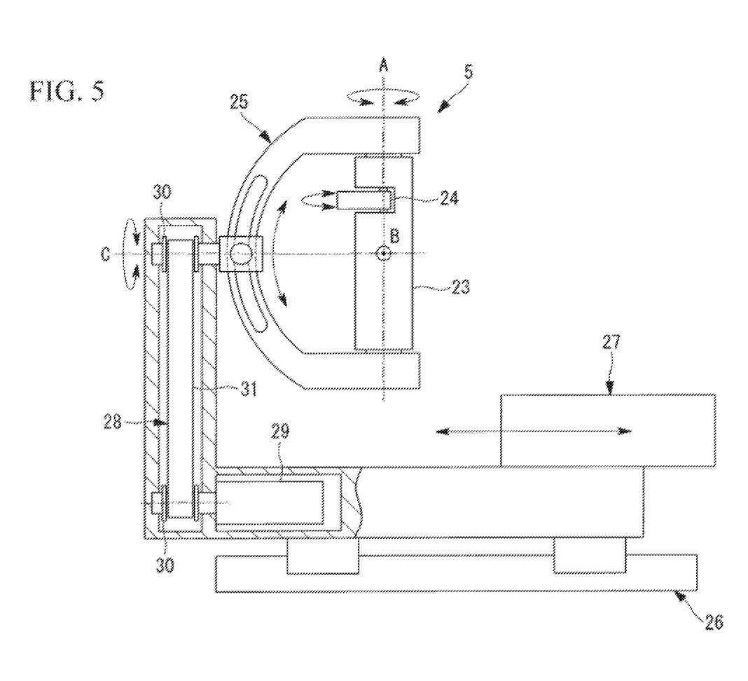

As shown in FIG. 5, the operating parts 5 have axis configurations substantially analogous to those of the movable part 9.

Specifically, the operating parts 5 each include a round-bar-shaped handle (rotation-operation input part, bending-operation input part) 23 to be grasped by a hand of an operator O, and a knob 24 that is provided on the handle 23 and is used to operate the treatment part 11.

The handle 23 is provided so as to be rotatable about three axes A, B, and C, which are perpendicular to one another, at the center of the handle 23 and is supported by a frame 25 having a so-called gimbal structure, The frame 25 has sensors (not shown) that detect the rotation angles of the handle 23 about the three axes A, B, and C.

The knob 24 is positioned and configured such that the knob can be operated when held between the index finger and the thumb of the hand that is grasping the handle 23 when the handle 23 is grasped in hand. The knob 24 also has a sensor (not shown) that detects the amount of operation of the knob 24.

The frame 25 that supports the handle 23 is supported by a linear motion bearing 26 so as to be slidable in the front-rear direction. An arm rest 27, on which the elbow or forearm of the hand that is grasping the handle 23 is placed, is fixed to the frame 25. The linear motion bearing 26 has a sensor (not shown) that detects the movement amount of the frame 25 in the front-rear direction.

In this embodiment, a rotation mechanism 28 that rotates the handle 23 about the third axis C is provided. The rotation mechanism 28 includes a motor 29, and pulleys 30 and a belt 31 that transmit the driving force of the motor 29 to the handle 23 to rotate the handle 23 about the third axis C.

The operating part 5 has a clutch switch (not shown), which enables input for switching between operable connection and disconnection of the movable part 9 and the operating part 5.

When the rotation angle of the handle 23 about the first, axis A is transmitted from the sensor, the control unit 6 generates an instruction signal for causing one of the first bend joint 14 and the second bend joint 15 to pivot by an angle corresponding to the rotation angle. When the rotation angle of the handle 23 about the second axis B is transmitted from the sensor, an instruction signal for causing the other of the first bend joint 14 and the second bend joint 15 to pivot by an angle corresponding to the rotation angle is generated.

When the rotation angle of the handle 23 about the third axis C is transmitted from the sensor, the control unit 6 generates an instruction signal for causing the rotation joint 13 to pivot by an angle corresponding to the rotation angle.

When the movement amount of the frame 25 in the front-rear direction is transmitted from the sensor, an instruction signal for causing the slide joint 12 to linearly move by a distance corresponding to the movement amount is generated.

In this case, in the manipulator system 1 according to this embodiment, when the operating part 5 and the movable part 9 are to be operably connected again from a state in which the clutch is disengaged, and the operating part 5 and the movable part 9 are not operably connected, the operator O moves the operating part 5 so as to substantially match the shape of the movable part 9 in the endoscope image displayed on the monitor 7, and then operates the clutch switch to input an instruction for engaging the clutch.

When an engaging instruction is input by operation of the clutch switch, the angles and positions of the joints 12, 13, 14, and 15 of the movable part 9 are transmitted to the control unit 6 on the basis of the signals from the sensors provided in the driving part 10 of the manipulators 3a and 3b.

The rotation angle of the handle 23 when the clutch is engaged is transmitted from the sensor of the operating part 5 to the control unit 6.

At this time, the control unit 6 associates the rotation angles of the handle 23 about the first axis A and the second axis B, detected by the sensors in the operating part 5, with the rotation angles of the first bend joint 14 and the second bend joint 15, detected by the sensors in the driving part 10 of the manipulators 3a and 3b. The position of the frame 25 in the front-rear direction, detected by the sensor in the operating part 5, and the positions of the slide joints 12 of the manipulators 3a and 3b, detected by the sensor in the driving part 10, are associated with each other.

Meanwhile, the angle of the rotation joint 13 of the movable part 9 is compared with the rotation angle of the handle 23 about the third axis C of the operating part 5, and, according to the relative angle Δθ, the rotation mechanism 28 is actuated to rotate the handle 23 about the third axis C, and the relative angle Δθ is adjusted to 0°, ±90°, or ±180°. Then, the movable part 9 is controlled as follows.

More specifically, when

−45°<Δθ≤45° (1),

the control unit 6 actuates the rotation mechanism 28 to rotate the handle 23 about the third axis C such that the relative angle Δθ=0°. Thereafter, the control unit 6 engages the clutch and controls the two bend joints 14 and 15, the rotation joint 13, and the slide joint 12 by using the coordinate system fixed to the intersection point of the three axes A, B, and C of the handle 23.

When

135°<Δθ≤225° (2),

the control unit 6 actuates the rotation mechanism 28 to rotate the handle 23 about the third axis C such that the relative angle Δθ=+180°. In this state, the control unit 6 resets, among the coordinate systems of the movable part 9, the coordinate systems of the two distal-end-side bend joints 14 and 15 to coordinate systems corresponding to the coordinate system fixed relative to the intersection point of the three axes A, B, and C of the handle 23. Then, the control unit 6 engages the clutch and controls the two bend joints 14 and 15, the rotation joint 13, and the slide joint 12 by using the new coordinate systems.

Similarly, when

−225°<Δθ≤−135° (3),

the control unit 6 actuates the rotation mechanism 28 to rotate the handle 23 about the third axis C such that the relative angle Δθ=−180°. In this state, the control unit 6 resets, among the coordinate systems of the movable part 9, the coordinate system of the two distal-end-side bend joints 14 and 15 to coordinate systems corresponding to the coordinate system fixed relative to the intersection point of the three axes A, B, and C of the handle 23. Then, the control unit 6 engages the clutch and controls the two bend joints 14 and 15, the rotation joint 13, and the slide joint 12 by using the new coordinate systems.

When

+45°<Δθ≤135° (4),

the control unit 6 actuates the rotation mechanism 28 to rotate the handle 23 about the third axis C such that the relative angle Δθ=90°. In this state, the control unit 6 resets, among the coordinate systems of the movable part 9, the coordinate systems of the two distal-end-side bend joints 14 and 15 to coordinate systems corresponding to the coordinate system fixed relative to the intersection point of the three axes A, B, and C of the handle 23, and switches the correspondence relationship between the rotation of the handle 23 about the first axis A and the second axis B and the rotation of the first bend joint 14 and the second bend joint 15. Thereafter, the control unit 6 engages the clutch and controls the two bend joints 14 and 15, the rotation joint 13, and the slide joint 12 by using the new coordinate systems.

Similarly, when

−135°<Δθ≤−45° (5),

the control unit 6 actuates the rotation mechanism 28 to rotate the handle 23 about the third axis C such that the relative angle Δθ=−90°. In this state, the control unit 6 resets, among the coordinate systems of the movable part 9, the coordinate systems of the two distal-end-side bend joints 14 and 15 to coordinate systems corresponding to the coordinate system fixed relative to the intersection point of the three axes A, B, and C of the handle 23, and switches the correspondence relationship between the rotation of the handle 23 about the first axis A and the second axis B and the rotation of the first bend joint 14 and the second bend joint 15. Thereafter, the control unit 6 engages the clutch and controls the two bend joints 14 and 15, the rotation joint 13, and the slide joint 12 by using the new coordinate systems.

Advantages of the thus-configured manipulator system 1 according to this embodiment will be described below.

When an affected part in the body is to be treated by using the manipulator system 1 according to this embodiment, the overtube 4 with the endoscope 2 and the two manipulators 3a and 3b inserted through the respective channels 16 is inserted into the body of a patient P. In this state, the clutches are disengaged, so that the operating parts 5 and the manipulators 3a and 3b are not operably connected.

In a state in which the distal end of the overtube 4 is disposed near the affected part in the body, the operator O causes the distal end of the endoscope 2 to project from the distal-end opening of the endoscope channel 17 and causes the two movable parts 9 to project from the distal-end openings of the manipulator channels 16. Thereafter, the overtube 4 is fixed to the driving part body 20, and the manipulator-side driving parts 21 are attached to the driving part body 20, and thus, the endoscope 2 is actuated.

The image acquired by the endoscope 2 shows the two movable parts 9, and the coordinate systems of the movable parts 9 on the monitor 7 and the coordinate systems fixed to the intersection points of the three axes A, B, and C of the handles 23 of the operating parts 5 correspond to each other. Hence, by initializing the movable parts 9 and the operating parts 5 and engaging the clutches in this state, when the handle 23 grasped in the right hand is operated, the right-side movable part 9 in the image displayed on the monitor 7 moves by a movement amount corresponding to the movement amount of the handle 23 in the same direction as the direction in which the handle 23 is operated. Similarly, when the handle 23 grasped in the left hand is operated, the left-side movable part 9 in the image moves by a movement amount corresponding to the movement amount of the handle 23 in the same direction as the direction in which the handle 23 is operated.

In this case, while the clutch is engaged, the correspondence relationship between the operation direction of the handle 23 and the moving direction of the movable part 9 is maintained. Specifically, even when the handle 23 is rotated about the third axis C by about 180°, the correspondence relationship does not change.

For example, when the treatment is interrupted for some reason in this state, and the handle 23 is returned to nearly 0° while the clutch is disengaged, the operator O who looks at the monitor 7 again misunderstands that the movable part 9 is in the state of 0°, and he/she makes, at that position, the angles about the axes A, B, and C of the handle 23 of the operating part 5 and the angles of the joints 13, 14, and 15 of the movable part 9 match, and then engages the clutch.

In the manipulator system 1 according to this embodiment, when a clutch engaging instruction is input, the angle of the rotation joint 13 of the movable part 9 detected by the sensor at that time is sent to the control unit 6 and is compared with the rotation angle of the handle 23 about the third axis C.

For example, when the rotation angle of the handle 23 about the third axis C is θ, and the rotation angle of the rotation joint 13 of the movable part 9 is θ+40°, the relative angle Δθ is 40°, which applies to Conditional Expression (1) above. Hence, the control unit 6 actuates the rotation mechanism 28 to set the rotation angle of the handle 23 about the third axis C to θ. As a result, the relative angle Δθ between the rotation angle of the handle 23 about the third axis C and the angle of the rotation joint 13 of the movable part 9 is accurately set to 0°.

At the relative angle Δθ=0°, the control unit 6 engages the clutch and, thereafter, performs control so as to move the movable part 9 according to the coordinate system fixed to the intersection point of the three axes A, B, and C of the handle 23.

For example, when the rotation angle of the handle 23 about the third axis C is θ, and the rotation angle of the rotation joint 13 of the movable part 9 is θ+50° or less, the relative angle Δθ is 50°, which applies to Conditional Expression (4) above. Hence, the control unit 6 actuates the rotation mechanism 28 to set the rotation angle of the handle 23 about the third axis C to θ+90°. As a result, the relative angle Δθ between the rotation angle of the handle 23 about the third axis C and the angle of the rotation joint 13 of the movable part 9 is accurately set to +90°.

At the relative angle Δθ=+90°, the control unit 6 makes the coordinate systems of the two distal-end-side bend joints, 14 and 15, of the movable part 9 correspond to the coordinate system fixed to the intersection point of the three axes A, B, and C of the handle 23, and switches the correspondence relationship between the rotation of the handle 23 about the first axis A and the second axis B and the rotation of the first bend joint 14 and the second bend joint 15. Thereafter, the control unit 6 engages the clutch and performs control so as to move the movable part 9 according to the coordinate system fixed to the handle 23.

More specifically, when the relative angle Δθ=0°, as described above, the control unit 6 causes the second bend joint 15 to pivot by an angle corresponding to the rotation angle of the handle 23 about the first axis A and causes the first bend joint 14 to pivot by an angle corresponding to the rotation angle of the handle 23 about the second axis B. In contrast, when the relative angle Δθ=90°, the control unit 6 causes the first bend joint 14 to pivot by an angle corresponding to the rotation angle of the handle 23 about the first axis A and causes the second bend joint 15 to pivot by an angle corresponding to the rotation angle of the handle 23 about the second axis B. Specifically, the bend joints 14 and 15 that move according to the operation directions of the handle 23 are switched. This is the same in the case where Δθ=−90°.

For example, when the rotation angle of the handle 23 about the third axis C is θ, and the rotation angle of the rotation joint 13 of the movable part 9 is θ+150°, the relative angle Δθ is +150°, and the control unit 6 actuates the rotation mechanism 28 to set the rotation angle of the handle 23 about the third axis C to θ+180°. As a result, the relative angle in of the rotation angle of the handle 23 about the third axis C and the angle of the rotation joint 13 of the movable part 9 are precisely set to +180°.

Then, at the relative angle Δθ=+180°, the control unit 6 makes the coordinate systems of the two distal-end-side bend joints 14 and 15 of the movable part 9 correspond to the coordinate system fixed to the intersection point of the three axes A, B, and C of the handle 23, thereafter, engages the clutch, and performs control so as to move the movable part 9 according to the coordinate system fixed to the handle 23.

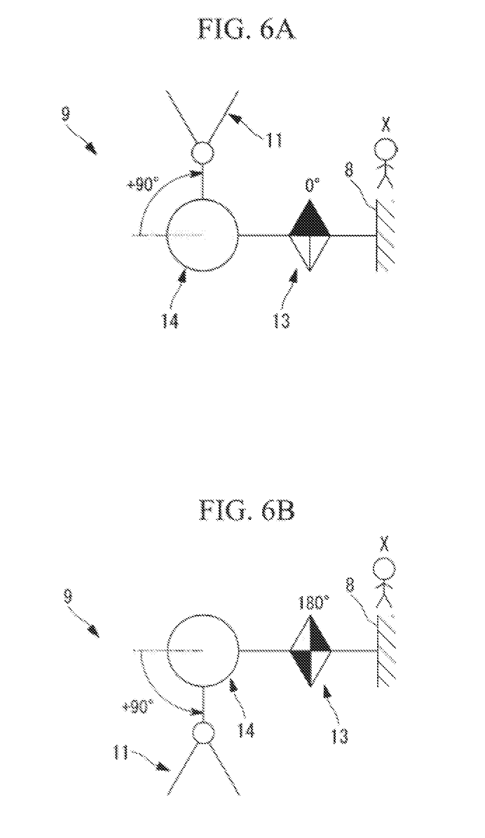

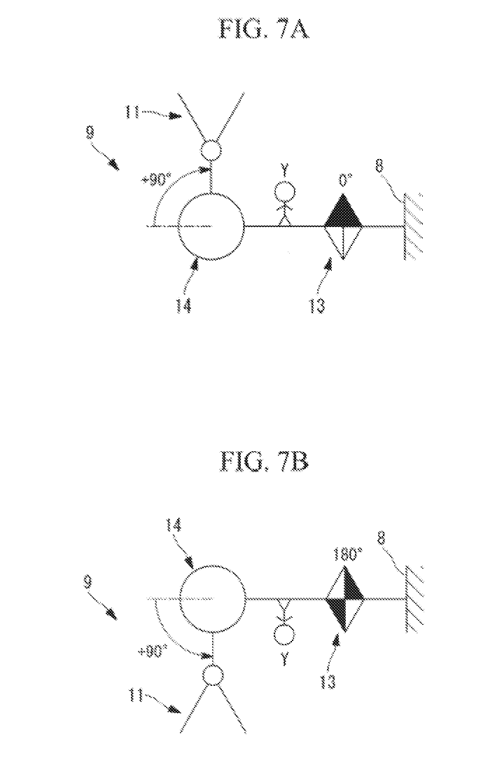

The idea of this control is equivalent to, in the movable part 9 in FIG. 4, the coordinate system of the operating part 5 being fixed to a member between the rotation joint 13 and the first bend joint 14, the member being rotated about the longitudinal axis by the rotation joint 13. Specifically, as shown in FIGS. 6A and 6B, assuming that a reference X is closer to the proximal end than the rotation joint 13 is, the same movement instruction to the bend joint 14 will be rotation instructions in opposite directions, depending on whether the angle of the rotation joint 13 is 0° or 180°. However, according to this embodiment, as shown in FIGS. 7A and 7B, by setting a temporary reference Y closer to the distal end than the rotation joint 13 is, the same movement instruction to the bend joint 14 in the operating part 5 will be the same movement as viewed from the temporary reference Y, regardless of the angle of the rotation joint 13.

In other words, there is an advantage in that, in any case, the operator O can quickly start the operation from the point where the orientations of the movable parts 9 displayed on the monitor 7 and the orientations of the handles 23 of the operating part 5s are substantially matched, without needing to be conscious of the rotation angles of the rotation joints 13 of the movable parts 9 displayed on the monitor 7. Specifically, the manipulator system 1 according to this embodiment has an advantage in that it is possible to move the movable parts 9 of the manipulators 3a and 3b as the operator O intends, regardless of the state of the rotation joints 13.

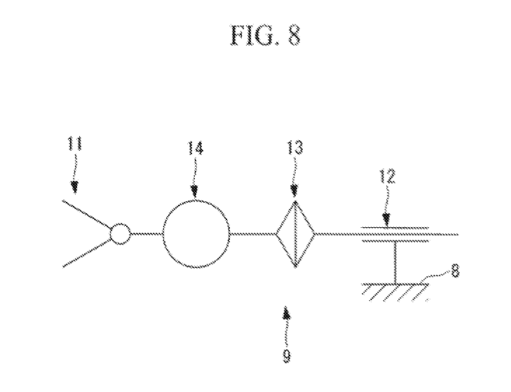

In this embodiment, an example case where the two bend joints 14 and 15 are provided closer to the distal end than the rotation joint 13 has been shown. Instead of this, as shown in FIG. 8, the present invention may be applied to the case where one bend joint 14 is provided closer to the distal end than the rotation joint 13 is. In that case, the relative angle Δθ is adjusted to 0° or 180°.

In this embodiment, an example case where the operating part 5 and the movable part 9 have substantially analogous axis configurations has been shown. Instead of this, the present invention may be applied to the case where the number of joints in the operating part 5 is greater than the number of joints in a slave. The slide joint 12 may be disposed closer to the distal end than the rotation joint 13 is.

In this embodiment, the angles of the joints 12, 13, 14, and 15 of the movable part 9 are controlled to be equal to the rotation angles about the three axes A, B, and C of the handle 23. Instead of this, the input from the handle 23 may be input in the form of a speed instruction.

Specifically, in that case, the joints 13, 14, and 15 of the movable part 9 are moved in the directions corresponding to the rotation directions of the handle 23, at speeds corresponding to the rotation angles of the handle 23 from the reference position.

This provides an advantage in that, even in the configuration in which it is difficult to achieve absolute accuracy because transmission of the driving force in the insertion part 8 varies due to friction, as in the manipulators 3a and 3b having the flexible insertion parts 8, it is possible to move the treatment parts 11 at the distal ends of the movable parts 9 to desired positions without stress in the operation.

In that case, it is necessary to return the handle 23 to the reference position (origin) to stop the movement of the movable part 9, and hence, it is desirable to provide a spring (urging member) that urges the handle 23 to the reference position. With this configuration, the operator O can return the handle 23 to the reference position and stop the movement of the movable part 9 merely by removing the force applied to the handle 23.

It is also possible to provide, not a spring, but a notification part (origin notification part) that notifies the operator O that the handle 23 is located at the reference position. The notification part may give the operator O who is grasping the handle 23 a clicking sensation when the handle 23 is located at the reference position or may notify the operator O of the reference position with light, sound or the like.

In this embodiment, the rotation mechanism 28 that rotates the handle 23 such that the relative angle between the rotation angle of the handle 23 about the third axis C and the angle of the rotation joint 13 is 0° or ±180°. Instead of this, it is possible to move the rotation joint 13 without the handle 23.

In this embodiment, although the handle 23 in which the rotation-operation input part that operates the rotation joint 13 and the bending-operation input part that operates the bend joints 14 and 15 are integrated has been shown as an example, the configuration is not limited thereto. For example, a configuration in which they are separated may be employed.

In this embodiment, although the operating part 5 in which the handle 23 is supported by the frame 25 of the gimbal structure has been shown as an example, the configuration is not limited thereto.

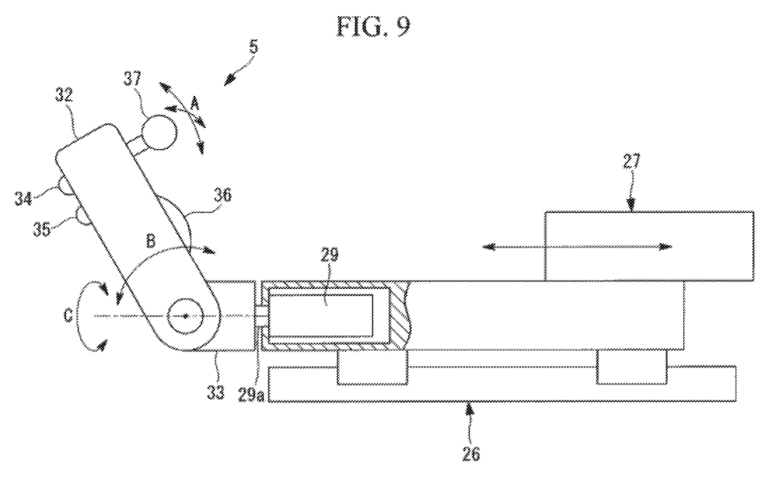

For example, as shown in FIG. 9, the operating part 5 may include a rotation member (rotation-operation input part) 33 that is joined to a shaft 29a of the motor 29, and a bar-shaped handle (bending-operation input part) 32 that is provided so as to be pivotable about a second axis B perpendicular to the rotation member 33 and that is grasped in hand by the operator O. The handle 32 is only necessary to be rotatable about the second axis B, in the range from the initial position at which the longitudinal axis thereof is aligned with or is at an angle of 90° or less with respect to the longitudinal axis (third axis C) of the shaft 29a to substantially 90° with respect to the longitudinal axis. The handle 32 may be configured to be returned to the initial position by a spring (not shown) when the operator O releases the handle 32.

In the example shown in FIG. 9, the handle 32 includes switches 34 and 35 that are used to operate the treatment part 11 and that are disposed at positions corresponding to the index finger and the middle finger of the hand grasping the handle 32 when the operator O is grasping the handle 32, a contact sensor 36 that detects contact of the base of the thumb of the grasping hand or the vicinity thereof, and a joystick-shaped lever (bending-operation input part) 37 that is disposed at a position corresponding to the thumb of the hand grasping the handle 32 and that moves the bend joint 15 at a speed corresponding to the pivot angle when pivoted by the thumb. The lever 37 is also configured to be returned to the neutral position by a spring (not shown) when the thumb of the operator is released,

As a result, the following aspect is read from the above described embodiment of the present invention.

An aspect of the present invention provides a manipulator system including a manipulator. The manipulator includes an insertion part a first bend joint configured to pivot a distal end part of the insertion part about an axis perpendicular to the longitudinal axis of the insertion part; a rotation joint configured to rotate the distal end part about the longitudinal axis; and an operation input part configured to input an operation instruction. The operation input part includes a bending-operation input part configured to input an operation instruction to the bend joint; a rotation-operation input part configured to input an operation instruction to the rotation joint; and a control unit comprising a hardware. The control unit is configured to control to move the rotation-operation input part or the rotation joint such that the relative angle between the operation instruction and the rotation angle of the rotation joint is 0° or ±180°.

In this aspect, when the control by the control unit is started in a state in which the operation input part and the manipulator are misaligned, the angles of the respective joints of the manipulator are detected, and the rotation-operation input part or the rotation joint is moved by the control unit such that the relative angle between the rotation angle of the rotation joint and the operation instruction input to the rotation-operation input part is 0° or ±180°. By making the relative angle 0°, the moving direction of the bend joint and the operation direction input by the bending-operation input part match.

Meanwhile, when the relative angle is ±180°, if nothing is done, the moving direction of the bend joint is opposite to the operation direction input by the bending-operation input part. However, because it is recognized that the relative angle is ±180°. It is possible to easily make, with the control unit, the moving direction of the bend joint and the operation direction input by the bending-operation input part match. Accordingly, in either case, it is possible to make one or more bend joints perform the same movement by the same operation by the operation input part. In other words, it is possible to move the manipulator as the operator intends, regardless of the state of the rotation joint.

In the above aspect, the bend joint may include a second bend joint configured to rotate the distal end part about axes perpendicular to each other, and the bending-operation input part configured to input the operation instruction to the first bend joint and the second bend joint.

With this configuration, the operator can move the manipulator as he/she intends by grasping the handle and rotating the handle about one of the axes intersecting each other to move one bend joint and rotating the handle about the other axis to move the other bend joint.

In the above aspect, the control unit may move the rotation-operation input part or the rotation joint such that the relative angle between the operation instruction input to the rotation-operation input part and the rotation angle of the rotation joint is 0°, ±90°, or ±180°.

With this configuration, not only in the case where the relative angle is 0° or ±180°, but also in the case where the relative angle between the operation instruction input to the rotation-operation input part and the rotation angle of the rotation joint is ±90°, it is possible to easily make, with the control unit, the moving direction of the bend joint and the operation direction input by the bending-operation input part match.

Specifically, when there are two bend joints that can rotate about axes perpendicular to each other, if nothing is done, when the rotation joint rotates by ±90°, the rotation directions of the two bend joints are switched, and the rotation direction of one bend joint is reversed. However, because it is recognized that the relative angle is ±90°, it is possible to easily make, with the control unit, the moving direction of the bend joint and the operation direction input by the bending-operation input part match, Accordingly, in any case, it is possible to make one or more bend joints perform the same movement by the same operation by the operation input part. In other words, it is possible to move the manipulator as the operator intends, regardless of the state of the rotation joint.

In the above aspect, the operation instruction input by the bending-operation input part may be speed instructions to the first bend joint and the second bend joint.

With this configuration, it is possible to perform an operation while associating the rotation angle input by the bending-operation input part and the moving speed of the bend joint.

In the above aspect, the bending-operation input part may include an urging member configured to urge the handle in a direction in which the handle returns to the origin position.

With this configuration, when a force is applied to the handle of the bending-operation input part, and the rotation angle is increased, the moving speed of the bend joint increases, and, when the force applied to the handle is removed, the handle is returned to the origin position by the urging member, and thus, it is possible to stop the bend joint.

In the above aspect, the bending-operation input part may include an origin notification part configured to allow the operator to recognize the origin of the handle.

With this configuration, when notified by the origin notification part, the operator can recognize that the handle of the bending-operation input part is at the origin.

### REFERENCE SIGNS

1 manipulator system

3a, 3b manipulator

5 operating part (operation input part)

6 control unit

8 insertion part

11 treatment part (distal end part)

13 rotation joint

14 first bend joint (bend joint)

15 second bend joint (bend joint)

23, 32 handle (rotation-operation input part, bending-operation input part)

33 rotation member (rotation-operation input part)

37 lever (bending-operation input part)

O operator

1. A manipulator system comprising:
a manipulator comprising:
an insertion part;
a first bend joint configured to pivot distal end part of the insertion part about an axis perpendicular to the longitudinal axis of the insertion part;
a rotation joint configured to rotate the distal end part about the longitudinal axis: and
an operation input part configured to input an operation instruction, wherein the operation input part comprises:
a bending-operation input part configured to input an operation instruction to the bend joint;
a rotation-operation input part configured to input an operation instruction to the rotation joint; and
a control unit comprising a hardware, the control unit is configured to control and move the rotation-operation input part or the rotation joint so that a relative angle between the operation instruction and a rotation angle of the rotation joint is 0° or ±180°.

2. The manipulator system according to claim 1, wherein the manipulator further comprises a second bend joint configured to rotate the distal end part about axes perpendicular to each other, and
the bending-operation input part configured to input the operation instruction to the first bend joint and the second bend joint.

3. The manipulator system according to claim 2, wherein the control unit is configured to move the rotation-operation input part or the rotation joint such that the relative angle between the operation instruction input to the rotation-operation input part and the rotation angle of the rotation joint is 0°, ±90°, or ±180°.

4. The manipulator system according to claim 2, wherein the operation instruction input by the bending-operation input part is speed instructions to the first bend joint and the second bend joint.

5. The manipulator system according to claim 4, wherein the bending-operation input part comprises an urging member configured to urge a handle in a direction in which the handle returns to an origin position.

6. The manipulator system according to claim 4, wherein the bending-operation input part comprises an origin notification part configured to allow the operator to recognize an origin of a handle.
